(19) United States
(12) Patent Application Publication
(10) Pub. No.: US 2010/0180875 A1
(43) Pub. Date: Jul. 22, 2010

(54) Seating control device for a valve for a split-cycle engine

(75) Inventors: Riccardo Meldolesi, Brighton (GB); Stephen Peter Scuderi, Westfield, MA (US)

Correspondence Address: EDWARDS ANGELL PALMER & DODGE LLP, P.O. BOX 55874, BOSTON, MA, 02205, US

(73) Assignee: The Scuderi Group, LLC, West Springfield, MA (US)

(21) Appl. No.: 12/321,640

(22) Filed: Jan. 22, 2009

(51) Int. Cl. F02B 33/22; F16K 25/00

(52) U.S. Cl. 123/70 R; 251/175

(57) ABSTRACT

A seating control device for a valve, comprising:
a vessel for containing a fluid;
an upper snubber element translatably receivable in the vessel for controlling the seating velocity of a valve associated therewith; and
a lower snubber element translatably receivable in the vessel, adjacent the upper snubber element, presenting a surface to the upper snubber element, for controlling the seating of the valve.

### TECHNICAL FIELD

The present invention relates to a seating control device for a valve. More specifically, the present invention relates to a seating control device for a valve of camless split-cycle engines.

### BACKGROUND OF THE INVENTION

For purposes of clarity, the term “conventional engine” as used in the present application refers to an internal combustion engine wherein all four strokes of the well known Otto or diesel cycle (the intake, compression, expansion and exhaust strokes) are contained in each piston/cylinder combination of the engine. Each stroke requires one half revolution of the crankshaft (180 degrees crank angle (CA)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including a crossover compression (XovrC) valve and a crossover expansion (XovrE) valve defining a pressure chamber therebetween.

U.S. Pat. No. 6,543,225 granted Apr. 8, 2003 to Carmelo J. Scuderi (the Scuderi patent) and U.S. Pat. No. 6,952,923 granted Oct. 11, 2005 to David P. Branyon et al. (the Branyon patent) each contain an extensive discussion of split-cycle and similar type engines. In addition the Scuderi and Branyon patents disclose details of prior versions of engines of which the present invention comprises a further development.

Referring to FIG. 1, a prior art split-cycle engine of the type similar to those described in the Branyon and Scuderi patents is shown generally by numeral 10. The split-cycle engine 10 replaces two adjacent cylinders of a conventional engine with a combination of one compression cylinder 12 and one expansion cylinder 14. The four strokes of the Otto cycle are “split” over the two cylinders 12 and 14 such that the compression cylinder 12 contains the intake and compression strokes and the expansion cylinder 14 contains the expansion and exhaust strokes. The Otto cycle is therefore completed in these two cylinders 12, 14 once per crankshaft 16 revolution (360 degrees CA).

During the intake stroke, intake air is drawn into the compression cylinder 12 through an inwardly opening (opening inward into the cylinder) poppet intake valve 18. During the compression stroke, the compression piston 20 pressurizes the air charge and drives the air charge through the crossover passage 22, which acts as the intake passage for the expansion cylinder 14.

Due to very high volumetric compression ratios (e.g., 40 to 1, 80 to 1 or greater) within the compression cylinder 12, an outwardly opening (opening outward away from the cylinder) poppet crossover compression (XovrC) valve 24 at the crossover passage inlet is used to control flow from the compression cylinder 12 into the crossover passage 22. Due to very high volumetric compression ratios (e.g., 40 to 1, 80 to 1 or greater) within the expansion cylinder 14, an outwardly opening poppet crossover expansion (XovrE) valve 26 at the outlet of the crossover passage 22 controls flow from the crossover passage 22 into the expansion cylinder 14. The actuation rates and phasing of the XovrC and XovrE valves 24, 26 are timed to maintain pressure in the crossover passage 22 at a high minimum pressure (typically 20 bar or higher) during all four strokes of the Otto cycle.

A fuel injector 28 injects fuel into the pressurized air at the exit end of the crossover passage 22 in correspondence with the XovrE valve 26 opening. The fuel-air charge fully enters the expansion cylinder 14 shortly after expansion piston 30 reaches its top dead center position. As piston 30 begins its descent from its top dead center position, and while the XovrE valve 26 is still open, spark plug 32 is fired to initiate combustion (typically between 10 to 20 degrees CA after top dead center of the expansion piston 30). The XovrE valve 26 is then closed before the resulting combustion event can enter the crossover passage 22. The combustion event drives the expansion piston 30 downward in a power stroke. Exhaust gases are pumped out of the expansion cylinder 14 through inwardly opening poppet exhaust valve 34 during the exhaust stroke.

With the split-cycle engine concept, the geometric engine parameters (i.e., bore, stroke, connecting rod length, compression ratio, etc.) of the compression and expansion cylinders are generally independent from one another. For example, the crank throws 36, 38 for the compression cylinder 12 and expansion cylinder 14 respectively may have different radii and may be phased apart from one another with top dead center (TDC) of the expansion piston 30 occurring prior to TDC of the compression piston 20. This independence enables the split-cycle engine to potentially achieve higher efficiency levels and greater torques than typical four stroke engines.

The actuation mechanisms (not shown) for crossover valves 24, 26 may be cam driven or camless. In general, a cam driven mechanism includes a camshaft mechanically linked to the crankshaft. A cam is mounted to the camshaft, and has a contoured surface that controls the profile of the valve lift (i.e. the valve lift from its valve seat, versus rotation of the crankshaft). A cam driven actuation mechanism is efficient and fast, but has limited flexibility.

Also in general, camless actuation systems are known, and include systems that have one or more combinations of mechanical, hydraulic, pneumatic, and/or electrical components or the like. Camless systems allow for greater flexibility during operation, including, but not limited to, the ability to change the valve lift height and duration and/or deactivate the valve at selective times.

FIG. 2 is an illustrative view of an exemplary valve lift profile 40, showing the distance of the valve head from the valve seat with respect to crank angle (CA).

Regardless of whether a valve is cam driven or actuated with a camless system, the valve lift profile 40 needs to be controlled to avoid damaging impacts when the valve is approaching its closed position against the valve seat. Accordingly, a portion of the profile—referred to herein as the “landing” ramp 41—may be controlled to rapidly decelerate the velocity of the valve as it approaches the valve seat. The valve lift at the point of maximum deceleration is defined herein as the landing ramp height 42. The landing ramp duration 43 is defined herein as the duration of time from the point of maximum deceleration to the point of landing on the valve seat. The velocity of the valve head when the valve contacts the valve seat is referred to herein as the seating velocity.

During interval A, the valve head lifts off and accelerates away from the valve seat. After it reaches maximum velocity, the valve head starts to decelerate towards a point of greatest (or maximum) valve lift 44. At the beginning of interval B, the valve head starts to accelerate back towards the valve seat. As with interval A, the valve head reaches its maximum velocity, before it starts to decelerate. The beginning of interval C indicates the start of the landing ramp 41, where the valve head is subject to maximum deceleration, causing a rapid reduction in the velocity of the valve head towards the valve seat. The landing ramp 41 may be configured so as to control the seating velocity.

Interval A shown in the exemplary valve lift profile 40 of FIG. 2 also features a “take-off ramp” 45, similar in shape to the landing ramp 41 of interval C. The take-off ramp controls the velocity of the valve head as it lifts off its valve seat, before experiencing rapid acceleration. The “take-off” ramp 45 of interval A is not essential. A valve lift profile may not include any “take-off” ramp.

In cam driven actuation systems, the landing ramp is defined by the profile of the cam; and its duration is proportional to the engine speed. In camless actuation systems, the landing ramp is actively controlled by a valve seating control device or system.

For split-cycle engines which ignite their charge after the expansion piston reaches its top dead center position (such as in the Scuderi and Branyon patents), the dynamic actuation of the crossover valves is very demanding. This is because the crossover valves 24 and 26 of engine 10 must achieve sufficient lift to fully transfer the fuel-air charge in a very short period of crankshaft rotation (generally in a range of about 30 to 60 degrees CA) relative to that of a conventional engine, which normally actuates the valves for a period of at least 180 degrees CA. This means that the crossover valves 24, 26 must actuate about four to six times faster than the valves of a conventional engine.

As a consequence of the faster actuation requirements, the XovrC and XovrE valves 24, 26 of the split-cycle engine 10 have a severely restricted maximum lift compared to that of valves in a conventional engine. Typically the maximum lift of these crossover valves 24, 26 is in the order of 2 to 3 millimeters, as compared to about 10-12 mm for valves in a conventional engine. Consequently, both the height and duration of the landing ramp for the XovrC and XovrE valves 24, 26, need to be minimized to account for the shortened maximum lift and faster actuation rates.

Problematically, the heights of the ramps of crossover valves 24 and 26 are so restricted that unavoidable variations in parameters that control ramp height and that are normally less significant in their effect on the larger lift profiles of conventional engines, now become critical. These parameter variations include, but are not limited to:
1) dimensional changes due to thermal expansion of the metal valve stem and other metallic components in the valve's actuation mechanism as engine operational temperatures vary;
2) the normal wear of the valve and valve seat during the operational life of the valve; and
3) manufacturing and assembly tolerances.

In conventional engines having a conventional cam driven valve train, where the cam geometry is the main control factor for the valve lift, the effects of these parameters have been addressed by adding an active lash control device, commonly referred to as a hydraulic lash adjuster (HLA). However, prior art HLAs are normally one of the main contributing factors in reducing valve train stiffness which, in turn, limits the maximum engine operating speed at which the valve train can safely operate and the acceleration that the valve train can achieve. Therefore, a prior art HLA cannot be used with the split cycle engine 10 in the conventional configuration, because the valves of a split cycle engine 10 need to actuate much more rapidly than those in a conventional engine.

In camless systems, as applied to conventional engines, prior art snubber systems are used to provide the landing ramp. As illustrated schematically in FIG. 3, a prior art snubber system 46 comprises a plunger 47 operable to enter into a fluid 48 in a vessel 49. The deceleration action of the plunger 47 is generated by the increase in pressure of the fluid 48 in the vessel. A major factor influencing the rate of increasing pressure is the increasing length of the leakage path 50 as the plunger 47 extends further into the vessel 49. The increase in pressure is therefore substantially linearly proportional to the length of the leakage path 50. Prior art snubber systems 46 such as these are suitable for conventional camless systems, where the landing ramp height is relatively larger than the desired landing ramp height of split cycle engine 10.

When such a prior art snubber system 46 is applied to split cycle engine 10, the length of the leakage path 50 required to provide adequate deceleration of XovrE and XovrC valve 24, 26, exceeds the height of the reduced size of landing ramp, necessarily required by a split cycle engine. Consequently, the seating velocity is too high for safe operation and, as a result, the crossover valve would crash against its seat.

There is a need, therefore, for a valve seating control device for a valve of a camless split-cycle engine, which can both (a) provide effective deceleration of the valve within the constraints of the reduced landing ramp height; and (b) automatically compensate for such factors as thermal expansion of actuation components, valve wear and/or manufacturing tolerances and the like.

### SUMMARY OF THE INVENTION

Accordingly, the present invention provides a seating control device for a valve, comprising:

a vessel for containing a fluid;

an upper snubber element translatably receivable in the vessel for controlling the seating velocity of a valve associated therewith; and

a lower snubber element translatably receivable in the vessel, adjacent the upper snubber element, presenting a surface to the upper snubber element, for controlling the seating of the valve.

In one embodiment, the seating control device is configured such that the resistance to movement of the upper snubber element in the vessel is different to the resistance to movement of the lower snubber element in the vessel.

In one embodiment, the seating control device is configured such that the resistance to movement of the upper snubber element in the vessel is less than the resistance to movement of the lower snubber element in the vessel.

In one embodiment, the average clearance between the upper snubber element and the wall of the vessel is different to the average clearance between the lower snubber element and wall of the vessel.

In one embodiment, a spacer is provided between the upper snubber element and the lower snubber element to limit the minimum separation between the upper snubber element and the lower snubber element.

In one embodiment, the position of the lower snubber element with respect to the vessel is hydraulically controlled.

In one embodiment, the vessel has a substantially closed end, the valve seating control device further having a lower port between the lower snubber element and the closed end of the vessel, through which a supply of the fluid may be introduced.

In one embodiment, the seating control further comprises a pump to supply fluid under positive pressure to the lower port.

In one embodiment, the seating control device further comprises a control unit to control the supply of fluid to the vessel.

In one embodiment, a spacer is provided between the lower snubber element and the closed end of the vessel, to limit the minimum separation between the lower snubber element and the closed end of the vessel.

In one embodiment at least a part of the spacer is resilient.

In one embodiment, the seating control further comprises a lever associated with the lower snubber element to control its position with respect to the vessel.

In one embodiment, the seating control device further comprises a hydraulic lash adjuster associated with the lever.

In one embodiment, the seating control device further comprises a pump to supply fluid under positive pressure to the hydraulic lash adjuster.

In one embodiment, the seating control further comprises a control unit to control the supply of fluid to the hydraulic lash adjuster.

In one embodiment, the seating control further comprises an upper port provided between the upper snubber element and the lower snubber element through which a supply of fluid may be introduced.

In one embodiment, the upper snubber element is substantially disk shaped and the upper port is provided in the vicinity of the center of the lower face of the upper snubber element adjacent the lower snubber element.

In one embodiment, flow of fluid from the vessel through either or both the lower and upper ports is prevented.

In one embodiment, the upper snubber element is connected to a valve stem.

In one embodiment, the seating control device is configured such that, in use, the distance between the upper and lower snubber elements, before the associated valve opens, converges towards a predetermined distance.

The present invention further provides a split-cycle engine, comprising:

a crankshaft rotatable about a crankshaft axis;

a compression piston slideably received within a compression cylinder and operatively connected to the crankshaft such that the compression piston reciprocates through an intake stroke and a compression stroke during a single rotation of the crankshaft;

an expansion (power) piston slideably received within an expansion cylinder and operatively connected to the crankshaft such that the expansion piston reciprocates through an expansion stroke and an exhaust stroke during a single rotation of the crankshaft;

a crossover passage interconnecting the compression and expansion cylinders, the crossover passage including a crossover compression (XovrC) valve and a crossover expansion (XovrE) valve defining a pressure chamber therebetween; and

a seating control device associated with at least one of the crossover compression (XovrC) valve and crossover expansion (XovrE) valve, the device comprising:
a vessel containing a fluid;
an upper snubber element translatably receivable in the vessel for controlling the seating velocity of the valve; and
a lower snubber element translatably receivable in the vessel, adjacent the upper snubber element, presenting a surface to the upper snubber element, for controlling the seating of the valve.

The present invention further provides a method of controlling the seating of a valve, the method comprising:

providing a seating control device comprising: a vessel containing a fluid; an upper snubber element translatably receivable in the vessel for controlling the seating velocity of a valve associated therewith; and a lower snubber element translatably receivable in the vessel, adjacent the upper snubber element, presenting a surface to the upper snubber element;

associating the upper snubber element with a stem of the valve, the upper snubber element controlling the velocity of the valve as the upper snubber element approaches the surface of the lower snubber element; and

controlling the position of the lower snubber element with respect to the vessel.

### BRIEF DESCRIPTION OF THE DRAWINGS

FIG. 1 is a schematic cross-sectional view of a prior art split-cycle engine;

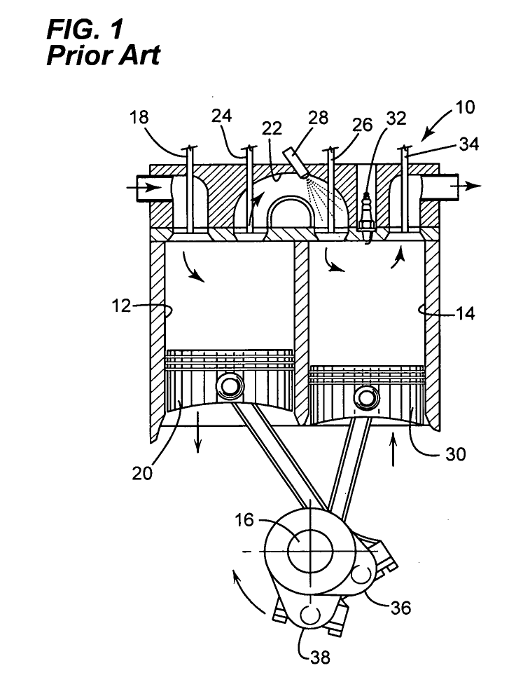

FIG. 2 is an illustrative view of an exemplary valve lift profile;

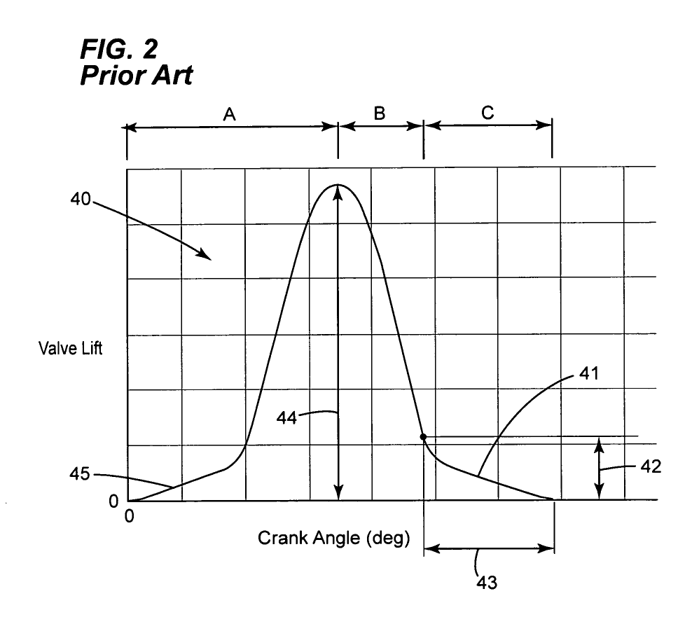

FIG. 3 is a schematic illustration of a prior art snubber system;

FIG. 4. is a cross-sectional and part schematic view of a split-cycle engine embodying the present invention, incorporating a seating control device for a valve according to a first embodiment of the present invention;

FIG. 5A. is a cross-sectional and part-schematic view of a seating control device for a valve according to a first embodiment of the present invention;

FIG. 5B is an enlarged view of the seating control device of FIG. 5A;

FIG. 6 is a cross-sectional and part-schematic view of split-cycle engine embodying the present invention, incorporating a seating control device for a valve according to a second embodiment of the present invention;

FIG. 7A is a cross-sectional and part-schematic view of a seating control device for a valve according to a second embodiment of the present invention;

FIG. 7B is an enlarged view of the seating control device of FIG. 7A;

FIG. 8 is a cross-sectional and part-schematic view of a seating control device for a valve according to a third embodiment of the present invention; and

FIG. 9 is a cross-sectional and part-schematic view of a seating control device for a valve according to a fourth embodiment of the present invention;

FIG. 10 is an illustrative view of an exemplary upper and lower snubber element lift profiles having a predetermined nominal distance just before valve opening in accordance with the first embodiment of the present invention; and

FIG. 11 is an illustrative view of the nominal upper and lower snubber element lift profiles of FIG. 10 with exemplary deviations to the lower snubber element lift profile supper imposed thereon in accordance with the present invention.

### DETAILED DESCRIPTION OF THE INVENTION

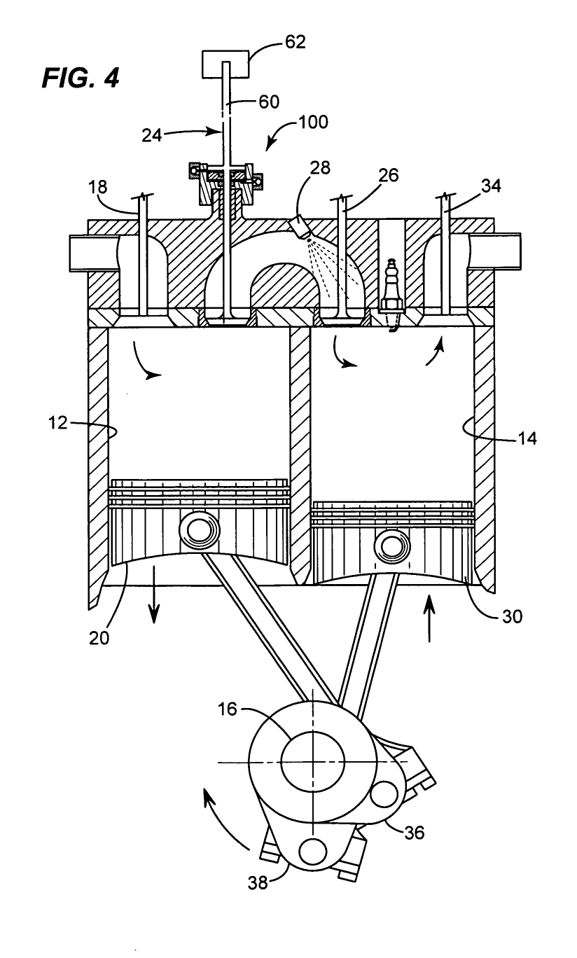

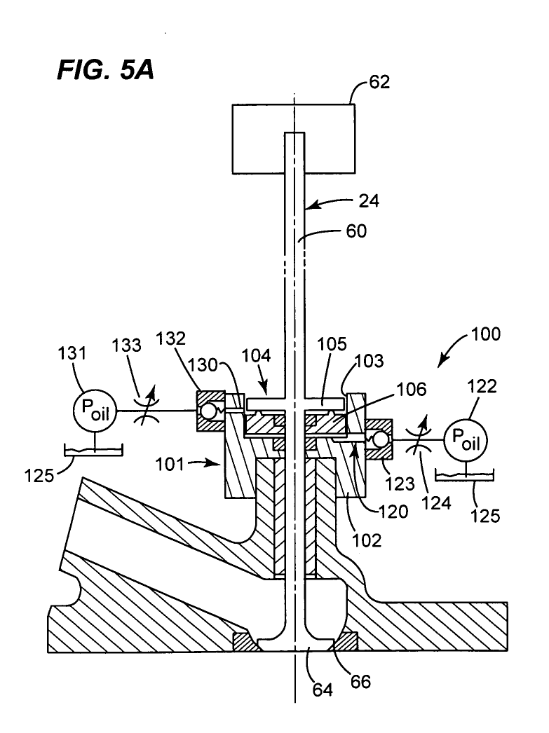

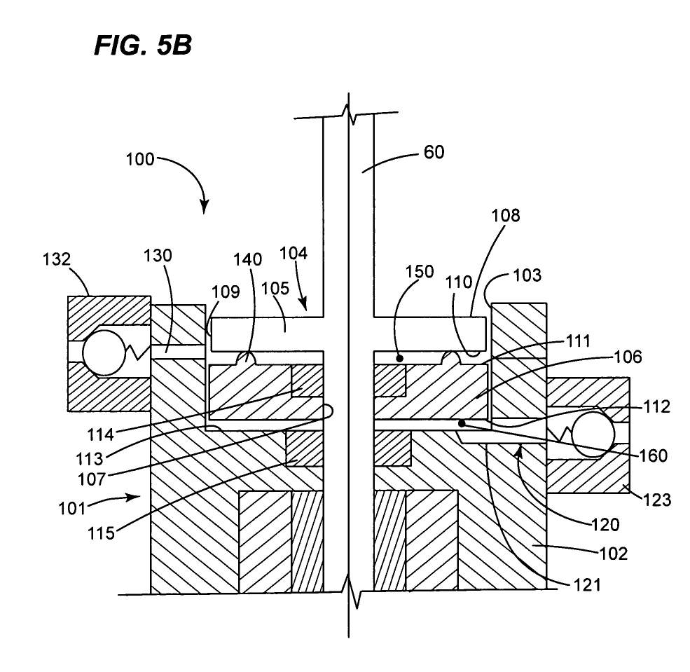

FIGS. 4, 5A and 5B show a seating control device 100 according to a first embodiment of the present invention. In FIG. 4, the device 100 is shown connected, in line, with the valve stem 60 of the XovrC valve 24. In other embodiments, the device may be associated with the valve stem 60 by other means, for example a mechanical (lever, gearing etc) or hydraulic connection. Additionally, the seating control device 100 may be associated with the XovrE valve 26 (not shown).

The valve 24 is operated using a camless actuation system 62, shown schematically. The camless actuation system 62 may have one or more combinations of mechanical, hydraulic, pneumatic, and/or electrical components or the like.

With reference to FIGS. 5A and 5B, the seating control device 100 comprises a housing 101 having a base 102. The housing 101 has a central bore 103 defining a vessel 104, the vessel 104 containing a fluid. The fluid may be oil, or any other substantially incompressible fluid.

An upper snubber element 105 is translatably received in the vessel 104, within the fluid, to control the seating velocity of the valve 24, as will be described below. In the figures, the upper snubber element 105 is shown formed integrally with the valve stem 60. Alternatively, the upper snubber element 105 may be attached to the stem 60 in other ways; for example, an interference fit, a conical collet, a thread or the like.

Further, a lower snubber element 106 is translatably received in the bore 103. The lower snubber element 106 is adjacent the upper snubber element 105 and presents a surface 111 to the upper snubber element 105, to control the correct and accurate seating of the valve head 64 on its seat 66, as will be described in more detail below.

The lower snubber element 106 is provided with a central bore 107, through which the stem 60 of the valve 24 passes. A seal 114 is provided between the stem 60 and the bore 107, to substantially prevent the egress of fluid therebetween. A seal 115 is provided between the stem 60 and the base 102. A seal (not shown) may be provided between the lower snubber element 106 and the bore 103. The seals 114, 115 may alternatively be configured so as to allow at least partial leakage, the leaked fluid promoting lubrication of moving parts.

There is a predetermined clearance between the side surface 109 of the upper snubber element 105 and the bore 103.

The lower surface 110 of the upper snubber element 105 and the upper surface 111 of the lower snubber element 106 together define an upper volume 150. Movement of the upper snubber element 105 with respect to the lower snubber element 106 is resisted by an increase in pressure of the fluid in the upper volume 150.

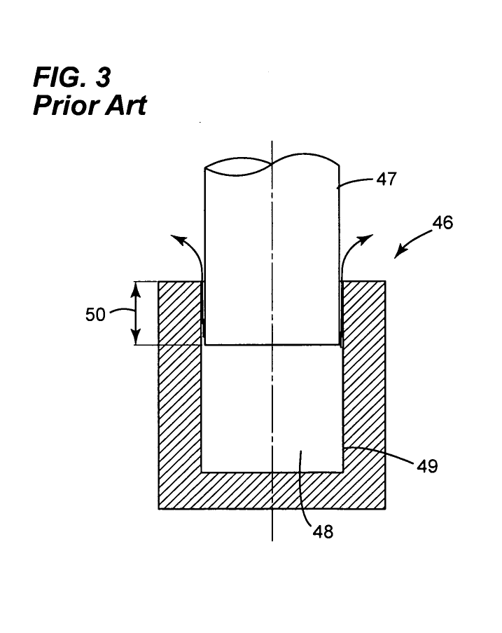

A prior art snubber system 46, such as that illustrated in FIG. 3, is necessarily and purposefully configured such that the major factor influencing the resistive pressure is the increasing length of the leakage path 50 as the plunger 47 extends further into the vessel 49. As described above, the increase in pressure is substantially linearly proportional to the length of the leakage path 50.

By contrast, the major factor influencing the increasing pressure in the present invention is the increasing resistance of the fluid escaping from the upper volume 150, as the upper snubber element 105 becomes close to, and rapidly approaches, the lower 106 snubber element. This is referred to as the ‘squish’ effect.

Advantageously, the increase in pressure caused by the squish effect is substantially and increasingly non-linear. Therefore, the resistance brought about by the squish effect provides the rapid deceleration required for the short landing ramp height of the crossover valve 24, to achieve an optimum seating velocity.

The upper snubber element 105 may always be substantially submerged in the fluid in the vessel 104, at both extremes of its cycle. In one embodiment, the upper snubber element 105 may only enter the vessel 104 (and thus the fluid provided therein) for a portion of the cycle of the valve. When the upper snubber element 105 is outside of the vessel 104, the valve 24 will thus not experience any resistance to movement from the vessel 104 and/or fluid.

Various parameters of the seating control device 100 may be configured to control the characteristics of the squish effect, thereby providing a landing ramp of a predetermined height, duration and profile in order to achieve an optimum seating velocity. Two such parameters are:
Parameter A) the distance between the upper 105 and lower 106 snubber elements at the point the valve 24 closes; or, alternatively,
Parameter B) the distance between the upper 105 and lower 106 snubber elements at the point the valve 24 opens.

Referring specifically to Parameter A, i.e., the distance between the upper 105 and lower 106 snubber elements at the point valve 24 closes, if the distance between the upper and lower snubber elements is too small as the valve closes, the magnitude of the squish effect will be too high, causing high deceleration, resulting in a low seating velocity, leading to excessive duration of the landing ramp, adversely affecting engine performance and efficiency. Conversely, if the distance is too large at the point of closure, the magnitude of the squish effect will be too low, causing low deceleration, resulting in a high seating velocity, causing the valve head 64 to crash against its valve seat 66, adversely affecting durability.

However, the distance (Parameter A) between the upper and lower snubber elements at the point valve 24 closes is difficult to maintain. This is because the distance is affected by various factors, such as thermal expansion of actuation components, valve wear and/or manufacturing tolerances. Undesired changes in this distance unacceptably vary the seating velocity.

In order to at least partially compensate for the adverse effects of these factors, the lower snubber element 106 is designed to be translatable with respect to the vessel 104. The lower snubber element 106 is translatable with respect to the vessel 104 so as to adjust the landing ramp portion of the valve lift profile, such that the seating velocity is maintained within a predetermined range.

In the first embodiment 100 shown in FIGS. 4, 5A and 5B, the bore 103 is a blind bore. Accordingly, the bottom surface 113 of the blind bore 103 defines a substantially closed end to the vessel 104. Additionally, the lower surface 112 of the lower snubber element 106 and the bottom surface 113 of the bore 103 define a lower volume 160.

In order to make the lower snubber element translatable, the position of the lower snubber element 106 with respect to the vessel 104 is hydraulically controlled, by altering the amount of fluid in the lower volume 160. Consequently in this embodiment 100, and as will be discussed in greater detail herein, the previously discussed Parameter A for controlling the squish effect, i.e., the distance between the upper 105 and lower 106 snubber elements at the point valve 24 closes is adjustable (i.e. it may no longer be a fixed distance).

A lower port 120 is provided in fluid communication with the lower volume 160. At least a part 121 of the lower port 120 is recessed in the bottom surface 113 of the bore 103. The recessed part 121 ensures that fluid passing through the lower port 120 may exert a force on at least a part of the lower surface 112 of the lower snubber element 106 even if the lower snubber element 106 abuts the bottom surface 113 of the bore 103.

A lower supply 122 of fluid at positive pressure (such as from a fluid pump or the like) is provided to the lower port 120. A check valve 123 is disposed between the vessel 104 and the supply of fluid 122, to prevent any fluid in the lower volume 160 from escaping through the check valve 123. A flow restrictor 124, of constant or variable effectiveness, is provided between the supply 122 and the check valve 123. A reservoir 125 provides fluid to the lower supply 122 of fluid.

Further, an upper port 130 is provided in fluid communication with the upper volume 150. In a similar way to the lower port 120, a supply 131 of fluid at positive pressure (such as from a fluid pump or the like) is provided to the upper port 130. A check valve 132 and flow restrictor 133 are provided between the supply 131 of fluid and the upper port 130, in the same way as with the lower port 120.

At least one spacer element 140 is provided on the upper surface 111 of the lower snubber element 106 to ensure a predetermined minimum distance between the upper 105 and lower 106 snubber elements. Alternatively, the spacer element(s) may be provided on the lower surface 110 of the upper snubber element 105 or it may be a separate ‘floating’ item in the upper volume 150, between the upper 105 and lower 106 snubber element. Alternatively, the spacer 140 may be omitted.

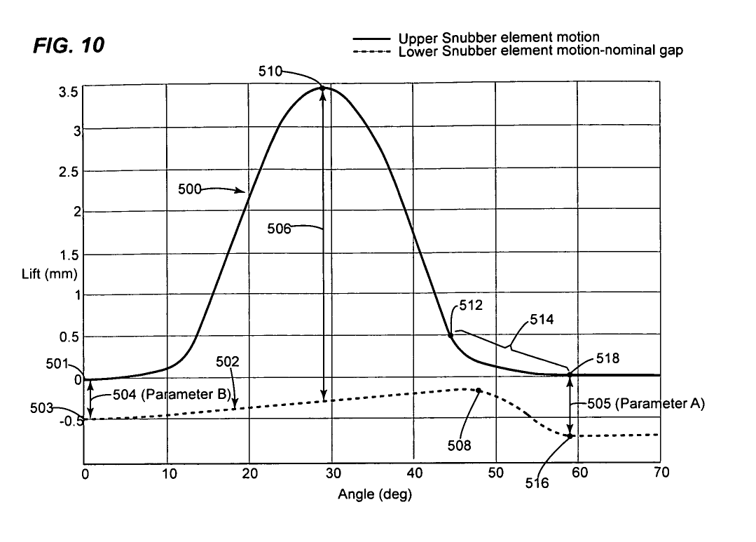

Referring now to FIG. 10, exemplary lift profiles of the upper 105 and lower 106 snubber elements relative to the vessel 104 are illustrated by lines 500 and 502 respectively. Since the upper snubber element 105 is rigidly attached to the stem 60 of valve 24, the graph 500 also represents an exemplary lift profile of valve head 64 of valve 24.

A factor utilized to control the squish effect and therefore the valve lift profile 500 is a predetermined nominal gap or distance 504 between the upper 105 and lower 106 snubber elements at the point the valve 24 opens, i.e., Parameter B as discussed earlier. In the exemplary embodiment of FIG. 10, the gap is set at 0.5 mm, but other gap distances may also be utilized to meet various design requirements. Alternatively, another factor that may be utilized to control the squish effect is the predetermined nominal distance 505 between the upper 105 and lower 106 snubber elements at the point the valve 24 closes, i.e., Parameter A as discussed earlier.

In the position shown in FIGS. 4, 5A and 5B, the valve 24 is at the beginning of an actuation cycle and the valve head 64 of valve 24 is closed against its seat 66. In the exemplary embodiment of FIG. 10, the beginning of the actuation cycle is set at 0.0 degrees crank angle, but the beginning of an actuation cycle can occur at various other points in a full 360 degree engine cycle.

Additionally at the beginning of the actuation cycle, the upper 105 and lower 106 snubber elements are in their respective starting positions 501 and 503 relative to the vessel 104. When the valve head 64 is caused to open by the actuating system 62, the valve head 64 will move away from the valve seat 66 and, accordingly, the upper snubber element 105, which is rigidly attached to the valve stem 60 of valve 24, will move with respect to the vessel 104. As a result, the distance between the upper 105 and lower 106 snubber elements will increase to its largest gap distance 506 as the valve 24 reaches its point of maximum lift 510 (approximately 3.4 mm above its original position 501 in the exemplary embodiment of FIG. 10).

To aid the separation of the upper snubber element 105 from the lower snubber element 106, the corresponding reduction in the pressure of the fluid in the upper 150 and lower 160 volumes causes the check valves 132, 123 to open. In turn, fluid is supplied, through the upper port 130, into the upper volume 150, therefore considerably limiting the reduction in pressure of the fluid in the upper volume 150; and thus reducing the resistance to movement of the upper snubber element 105. At the same time, fluid is supplied, through the lower port 120, into the lower volume 160. As a result, the lower snubber element 106 is caused to translate vertically upwards with respect to the vessel 104, away from the bottom surface 113 of the bore 103, until it reaches a point of maximum upwards travel 508 (approximately 0.3 mm above its original starting position 503 in the exemplary embodiment of FIG. 10).

By virtue of the association of the upper snubber element 105 with the valve stem 60, the upper snubber element 105 lifts further and faster than the lower snubber element 106. The extent of movement of the lower snubber element 106 is determined, substantially, by the rate of the supply 122 of fluid at the lower port 120.

As the valve head 64 reaches its maximum valve lift 510 from the valve seat 66, the valve head 64 begins to accelerate downwards towards the valve seat 66. Consequently, the upper snubber element 105 accelerates downward towards the lower snubber element 106.

As the valve head 64 approaches the valve seat 66, the distance between the upper 105 and lower 106 snubber elements will be reduced to a level where the squish effect will begin to cause the valve head 64 to rapidly decelerate. The point 512 of maximum deceleration defines the beginning of the landing ramp portion 514 of the valve's lift profile 500.

Accordingly, the pressure in the upper volume 150 will begin to increase which, in turn, will cause an increase in the pressure in the lower volume 160. At this point, the check valves 123, 132 of both the lower 120 and upper 130 ports will close, preventing the escape of fluid from the upper volume 150 through the upper port 130; and from the lower volume 160 through the lower port 120.

As the distance between the upper 105 and lower 106 snubber elements reduces still further, the pressure of the fluid in both the upper 150 and lower 160 volumes will increase, but not necessarily at the same rate.

There is a predetermined clearance (gap) provided between the side surface 109 of the upper snubber element 105 and the bore 103. Fluid expelled by the squish effect passes through the gap.

There is a predetermined clearance between the lower snubber element 106 and the bore 103, so as to permit a controlled amount of leakage. The clearance is configured such that fluid will be allowed to leak from the lower volume 160 into the upper volume 150. The rate of leakage is substantially proportional to the pressure of the fluid in the lower volume 160.

Accordingly, the lower snubber element 106 moves downwards (i.e. towards the bottom surface 113 of the bore 103) as a result of both the leakage from the lower volume 160 and the compressibility of the fluid in the lower volume 160. As a result, the imbalance of pressures between the upper volume 150 and lower volume 160 causes the lower snubber element 106 to move to a position 516 lower than its original starting position 503 (approximately 0.2 mm below its original starting position 503 in the exemplary embodiment of FIG. 10).

Accordingly, the lower snubber element 106, supported by the fluid in the lower volume 160, will provide a cushioning effect to the movement of the upper snubber element 105, therefore controlling the seating velocity.

At the point at which the valve head 64 closes against its seat 66 (i.e., the end of the landing ramp 518), the respective pressures in the upper 150 and lower 160 volumes are substantially at their highest value and the lower snubber element 106 is substantially at its lowest position 516 with respect to the vessel 104.

After the valve 24 has closed, the pressure of the fluid in the upper volume 150 is reduced by the further squishing of the fluid out of the upper volume 150. As a consequence, the lower snubber element 106 is allowed to raise, thereby releasing pressure in the lower volume 160 as the lower snubber element 106 approaches its original starting position 503 to begin another actuation cycle.

When the pressure in the lower volume 160 has reduced to a level below the opening pressure of the check valve 123 at the lower port 120, the check valve 123 will open, allowing the supply 122 of fluid to the lower port 120 into the lower volume 160. In turn, the supply 122 of fluid will cause the lower snubber element 106 to raise with respect to the vessel 104, approaching the upper snubber element 105.

As the valve 24 remains closed between actuation cycles, the lower snubber element 106 will continue to move towards the upper snubber element 105, until either: the spacer 140 contacts the lower surface 110 of the upper snubber element 105; or the pressure forces in the upper 150 and lower 160 volumes are substantially equalized. In either event, the upper 105 and lower 106 snubber elements will consequently approach a substantially predetermined distance 504 between upper 105 and lower 106 snubber elements at the point valve 24 opens. In other words, Parameter B for controlling the squish effect will approach a substantially constant nominal value. Preferably, the supply of fluid to the lower volume 160 through the lower port 120 is controlled such that, between the valve closing 518 and opening 504, the lower snubber element 106 moves by such an extent that the Parameter A distance 505 reduces to substantially equal the nominal predetermined Parameter B distance 504.

Preferably, the distance 504 between the upper 105 and lower 106 snubber elements at the point of valve opening (Parameter B) is reduced to a predetermined fixed distance (or range of distance) in the beginning of each cycle of the valve motion. However, this is not a strict requirement, because the distance between the upper 105 and lower 106 snubber elements at the point of valve opening 504 is both self compensating and converging over multiple actuation cycles of the valve 24.

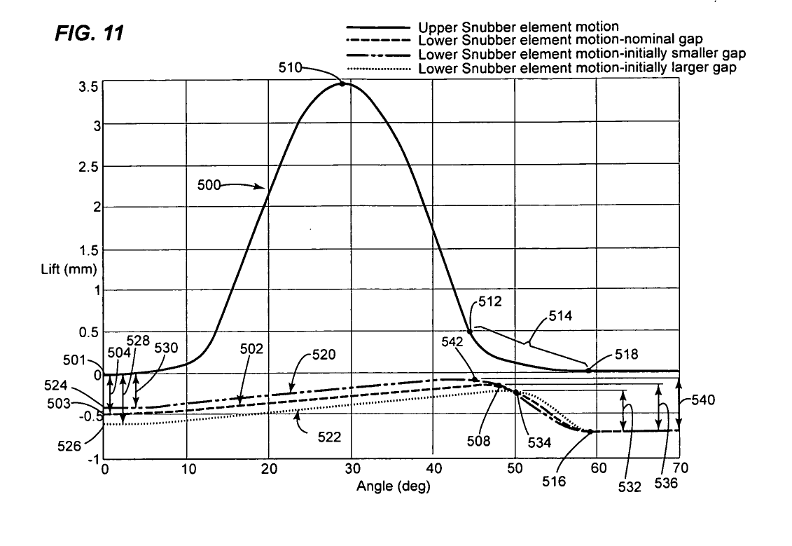

Referring to FIG. 11, this self compensating and converging effect is illustrated graphically with lower snubber element lift profiles 520 and 522. Lift profiles 520 and 522 represent deviations from the predetermined nominal lower snubber element lift profile 502 illustrated in FIG. 10. In lift profile 522, the starting position 526 of the lower snubber element 106 has deviated to a position that is lower than the predetermined nominal starting position 503 of lift profile 502. In lift profile 520, the starting position 524 of the lower snubber element 106 has deviated to a position that is higher than the predetermined nominal starting position 503 of lift profile 502.

Referring specifically to deviated lift profile 522 of FIG. 11, the distance 528 between the lower 106 and upper 105 snubber elements, at the point of valve opening, is greater than the predetermined nominal distance 504. Accordingly, the resistive force generated by the squish effect during the subsequent landing ramp 514, will be lower than in the previous cycle. Consequently, this reduced squish effect causes the lower snubber element 106 having the deviated lift profile 522 to descend a lesser distance 532 from its position of maximum lift 534 than the descent distance 536 from maximum lift 508 of the nominal lift profile 502. Accordingly, the two lift profiles 502 and 522 tend to approach each other after the point of valve closure 518.

Referring now specifically to deviated lift profile 520 of FIG. 11, distance 530 between the lower 106 and upper 105 snubber elements, at the point of valve opening, is smaller than the predetermined nominal distance 504. Accordingly, the resistive force generated by the squish effect during the subsequent landing ramp 514, will be greater than in the previous cycle. Consequently, this enhanced squish effect causes the lower snubber element 106 having the deviated lift profile 520 to descend a greater distance 540 from its position of maximum lift 542 than the descent distance 536 from maximum lift 508 of the nominal lift profile 502. Accordingly, the two lift profiles 502 and 520 tend to approach each other after the point of valve closure 518.

Accordingly, the distance between the upper 105 and lower 106 snubber elements is both self-compensating and converging because the system is constantly seeking to reach a predetermined (equilibrium) distance (or range of distance) between the upper 105 and lower 106 snubber elements. This capability of the seating control device 100 automatically compensates for the adverse effects of the variations in position of the upper snubber 105 element, caused by factors such as thermal expansion of actuation components, valve wear and/or manufacturing tolerances and the like.

A spacer (not shown) may be provided between the lower snubber element 106 and the closed end 113 of the vessel 104. The spacer may be similar or identical to the spacer 140 provided between the upper 105 and lower 106 snubber elements. The spacer may be attached to either of the lower snubber element 106 and end 113 of the vessel, or could be ‘floating’ therebetween. The spacer may comprise a ring, a protruding tab or equivalent.

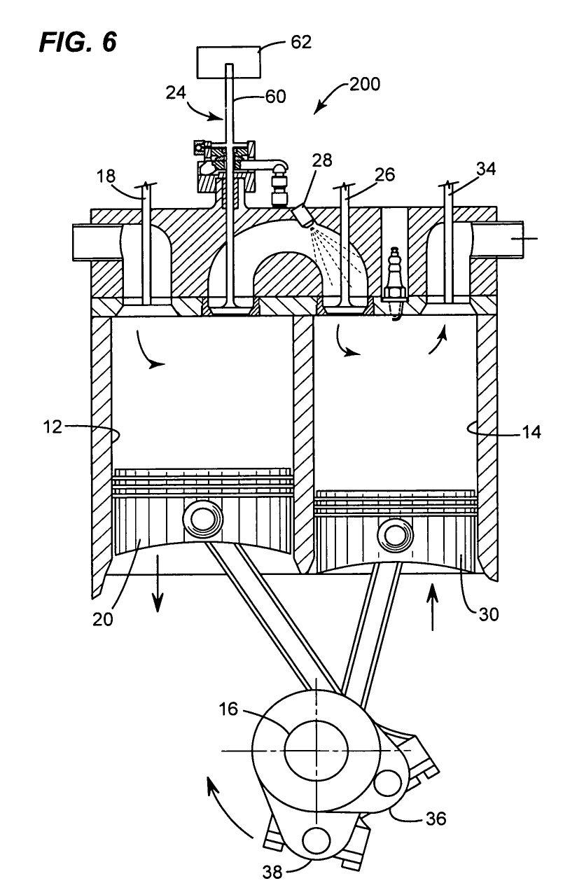

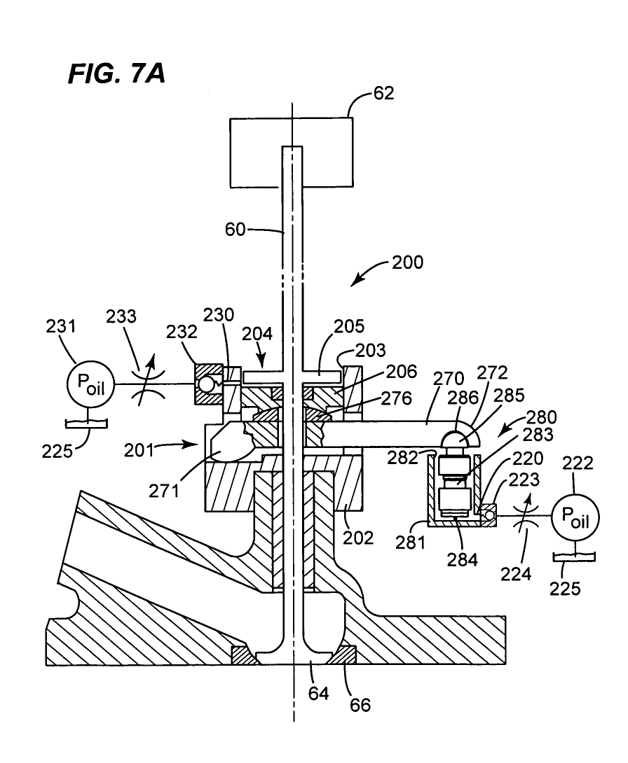

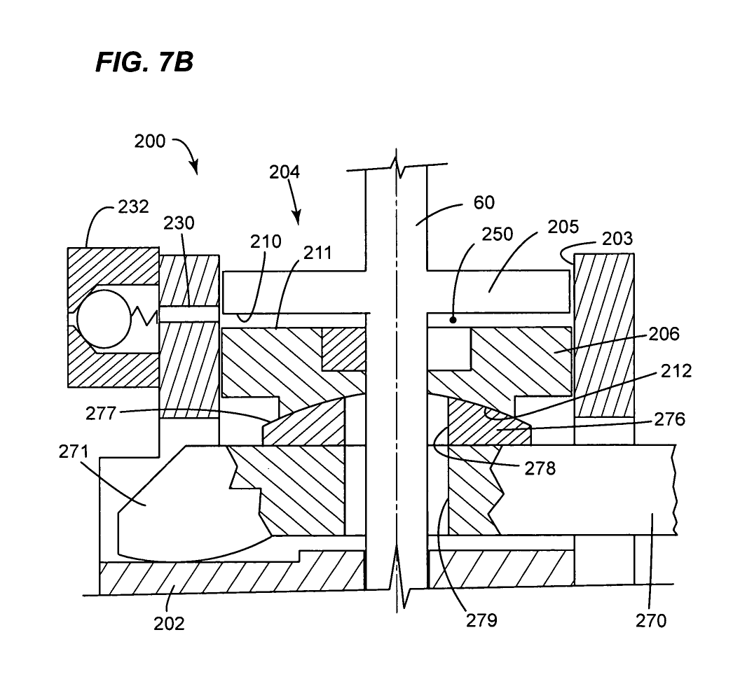

FIGS. 6, 7A and 7B illustrate a valve seating control device 200 according to a second embodiment of the present invention. Like features, as compared to those of the first embodiment, are denoted by corresponding numerals, increased by 100.

With reference to FIGS. 7A and 7B, the seating control device 200 comprises a housing 201 having a base 202. The housing 201 has a central bore 203 defining a vessel 204, the vessel 204 containing a fluid. The fluid may be oil, or any other substantially incompressible fluid.

An upper snubber element 205 has a lower surface 210. The upper snubber element 205 is translatably received in the vessel 204, within the fluid. In the figures, the upper snubber element 205 is shown formed integrally with the valve stem 60. Alternatively, the upper snubber element 205 may be attached to the stem 60 in other ways; for example, an interference fit, a conical collet, a thread or the like.

Further, a lower snubber element 206 has an upper surface 211. The lower snubber element 206 is translatably received in the bore 203. The lower snubber element 206 is adjacent the upper snubber element 205 and presents its upper surface 211 to the lower surface 210 of the upper snubber element 205, to control the correct and accurate seating of the valve head 64 on its seat 66.

The lower surface 210 of the upper snubber element 205 and the upper surface 211 of the lower snubber element 206 together define an upper volume 250. Movement of the upper snubber element 205 with respect to the lower snubber element 206 is resisted by an increase in pressure of the fluid in the upper volume 250 (i.e., the squish effect) in much the same way as discussed previously in the first embodiment 100.

In this second embodiment, the position of the lower snubber element 206 is controlled by a lever 270, pivotable at a first end 271, to control the position of the lower snubber element 206 with respect to the vessel 204. A second end 272 of lever 270 is associated with a hydraulic lash adjuster 280, the function of which will be described in more detail below.

A bearing element 276 is provided between the lever 270 and an arcuate lower surface 212 of the lower snubber element 206. The bearing element 276 has a substantially arcuate upper surface 277, which engages with the corresponding arcuate surface 212 of the lower snubber element 206. The bearing element 276 and lever 270 are provided with bores 278, 279 to receive the stem 60 of valve 24 therein. The bores 278, 279 are sized such that they do not contact the stem 60 at any point of rotation of the lever 270.

As the lever 270 rotates about its first end 271 (the pivot) in an anticlockwise direction, the lever 270 imparts a force having both a horizontal and vertical component on the bearing element 276. The arcuate upper surface 277 of bearing element 276 engaging with the corresponding arcuate lower surface 212 of lower snubber element 206 serves to eliminate or reduce any non-vertical component of the force being imposed on the lower snubber element 206. It is preferable that any forces on the lower snubber element 206 are directly purely coaxial with the longitudinal axis of bore 203. Non-vertical forces may otherwise cause the lower snubber element 206 to seize with respect to the bore 203, and/or wear may be caused.

Any non-vertical component imparted by the lever 270 instead causes the bearing element 276 to rotate with respect to the lower snubber element 206. Accordingly, the two arcuate surfaces 277 and 212 slide with respect to each other, such that only vertical forces are significantly subjected on the lower snubber element 206 by the bearing element 276.

The hydraulic lash adjuster (HLA) 280 is associated with the second end 272 of the lever 270. In embodiment 200, the HLA 280 is connected by a tappet 285 abutting against a curved recess 286 within the second end 272 of the lever 270. Alternatively, the connection may be a sliding tappet (or pin) extending through a slotted end of the lever 270.

The HLA 280 includes a body 281 having a central cylindrical bore 282. A plunger 283 is moveable in the bore 282. The plunger 283 has a predetermined clearance within the HLA bore 282. The plunger 283 and a closed end of the bore 282 define an HLA volume 284. The tappet, which abuts against the second end 272 of lever 270, is mounted atop the plunger 283.

A lower port 220 is provided in fluid communication with the HLA volume 284. A lower supply 222 of fluid at positive pressure (such as a fluid pump or the like) is provided to the lower port 220. A check valve 223 is disposed between the HLA volume 284 and the lower supply 222, to prevent any fluid in the HLA volume 284 escaping through the check valve 223. A flow restrictor 224, of constant or variable effectiveness, is provided between the supply 222 and the check valve 223. A reservoir 225 provides fluid to the lower supply 222 of fluid.

Further, an upper port 230 is provided in fluid communication with the upper volume 250. In a similar way to the lower port 220, a supply 231 of fluid at positive pressure (such as from a fluid pump or the like) is provided to the upper port 230. A check valve 232 and flow restrictor 233 are provided between the supply 231 of fluid and the upper port 230, in the same way as with the lower port 220.

The lower volume 160 of the first embodiment 100 may be seen as comparable to the HLA volume 284 of the second embodiment 200. In both cases, the introduction of fluid at the lower ports 120, 220 causes the lower snubber elements 106, 206 to translate with respect to the vessel 104, 204.

Fluids for use in both the lower volume 160 and HLA volume 284 of both embodiments 100, 200 of the invention are known to have some level of compressibility, either inherent or owing to the introduction of a variable percentage of air (aeration) during use. The effects of compressibility may be disadvantageous, since the positions and behavior of the upper 105, 205 and lower 106, 206 snubber elements may be difficult to predict. For a given force F applied to the upper 105, 205 and lower 106, 206 snubber plates, the fluid may compress by a distance X. The ratio of F to X is termed “stiffness”. A low stiffness—i.e. a high level of compressibility in the fluid—may cause an undesired reduction in the landing ramp height (because the fluid compresses before it ‘squishes’), which may cause the valve head 64 of valve 24 to impact on its valve seat 66 during landing. Additionally, a large degree of variability in stiffness, due to a large degree of variability in aeration, will undesirably vary the shape of the landing ramp.

By providing the lever 270 of the valve seating control device 200 embodying the present invention, the apparent stiffness (F/X) of the HLA 280 acting on the HLA volume 284 may be increased and the effects of variation in aeration on that stiffness will be decreased. In other words, the negative effects of compressibility may be lessened or overcome. This is because of the mechanical advantage brought about by the point at which the HLA 280 is connected to the lever 270, as compared to the HLA 280 acting directly on the lower snubber element 206. That is, when a force F1 is imparted on the lower snubber element 206 during operation, the force F2 imparted on the HLA 280 will be lower by the ratio (lever ratio) of the distance from the first end 271 to the second end 272, divided by the distance from the first end 271 to the center of the lower snubber element 206. By way of example, if the lever ratio is 10 to 1, then the force F2 acting on the HLA 280 will be one tenth of the force F1 acting on the lower snubber plate 206. This lower force F2 is, in turn, imparted on the HLA plunger 283.

Because the force F2 is reduced by a factor of the lever ratio, the distance X2 that the fluid in the HLA volume 284 will be compressed is also reduced by a factor of the lever ratio; as compared to the distance X1 that the fluid would have been compressed if the fluid had been acted directly upon by the force F1 on the lower snubber element 206. Again, by way of example, if the lever ratio is 10 to 1, then the compression distance X2 of HLA volume 284 at the second end 272 of the lever 270 is one tenth of the compression distance X1 of that same HLA volume 284 if it had been located directly under the lower snubber element 206. Accordingly, the stiffness at the HLA 280 is increased by the square of the lever ratio, or, in this exemplary case, by a factor of 100.

As a result, the valve seating control device 200 of the second embodiment may be stiffer than that of the valve seating control device 100 and thus less effected by compressibility of the fluid. Additionally, the variations in the aeration of the fluid will also have less of an effect on the variations in stiffness, and therefore cause proportionally smaller variations in the shape of the landing ramp.

Preferably, the valve seating control device 100, 200 comprises a controller (not shown), to control at least one of the upper 131, 231 and lower 122, 222 fluid supplies and flow restrictors 124, 224, 133, 233. There may be a plurality of sensor inputs to the controller, which determine the flow rate of fluid, so as to affect the rate of movement of the lower snubber element 106, 206 with respect to the vessel 104, 204.

In a further embodiment, movement of the lower snubber element with respect to the bore may be affected by an electromagnetic actuation device. An electromagnetic coil or coils may be provided around the exterior of the bore. The coil may be charged to create a magnetic field, which causes the lower snubber element to move with respect to the bore, thereby controlling its position.

With both the first 100 and second 200 embodiments, it will be appreciated that should the lower surface 110, 210 of the upper snubber element 105, 205 move below the upper port 130, 230, the upper port 130, 230 would no longer be operable to introduce fluid between the upper 105, 205 and lower 106, 206 snubber elements. Preferably, therefore, the upper port 130, 230 is provided at a location where it will substantially always be in communication with the upper volume 150, 250 between the upper 105, 205 and lower snubber 106, 206 elements.

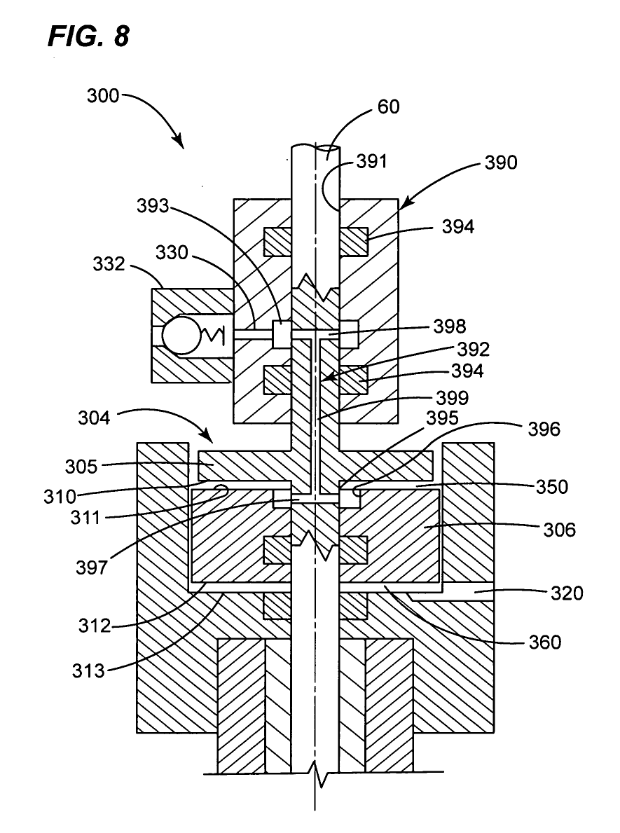

FIG. 8 shows a valve seating control device 300 according to a third embodiment of the present invention having an alternative sliding fluid connection 390 in order to facilitate the separation of upper and lower snubber elements 305 and 306 during operation. The valve seating control device 300 functions in much the same manner as the previous embodiments 100, 200. Accordingly, device 300 includes an upper snubber element 305 rigidly attached to stem 60 of valve 24, and a translatable lower snubber element 306. Both upper 305 and lower 306 snubber elements are disposed in a closed vessel 304 for containing the fluid. A lower surface 310 of upper snubber element 305 and an upper surface 311 of lower snubber element 306 define an upper volume 350 therebetween. Additionally a lower surface 312 of the lower snubber element 306 and a bottom surface 313 of the vessel 304 define a lower volume 360. The squish effect, which occurs as the upper snubber element rapidly approaches the lower snubber element and fluid pressure rapidly increases in the upper volume 350, is utilized to control seating of valve 24.

The sliding fluid connection 390 is provided to communicate pressurized fluid from an upper port 330 to a central section of upper volume 350 in order to provide a pressure boost in the initial separation of the upper 305 and lower 306 snubber plates just as the valve 24 is opening. Fluid flows under positive pressure through check valve 332 into the upper port 330 in much the same way as discussed in the first 100 embodiment. Also fluid flows under positive pressure through a lower port 320 into lower volume 360 in much the same way as discussed in the first embodiment 100.

The sliding connection 390 comprises a bore 391, in which the stem 60 of valve 24 is slidably received. A fluid supply bore 392 is provided in the stem 60 and includes a main vertical section 399 extending substantially along the center axis of stem 60. Fluid supply bore 392 also includes upper end 398 and lower end 397, which are in fluid communication with opposing ends of the main vertical section 399 of bore 392. Both upper and lower ends 398, 397 extend horizontally through the diameter of stem 60 and substantially perpendicular to the central axis of stem 60.

A fluid transfer volume 393 is provided between the upper port 330 and the bore 391. Fluid from the upper port 330 fills a transfer volume 393. In turn, fluid is communicated from the transfer volume 393 to the fluid supply bore 392. The transfer volume 393 is sized such that a positive supply of fluid may be communicated to the supply bore 392 even when the valve 24 is beginning to open and stem 60 is initially sliding with respect to the bore 391. However, when the stem 60 moves the upper end 398 of the supply bore 392 out of fluid connection with the transfer volume 393, the supply of fluid stops. This prevents fluid unnecessarily being introduced at the upper port 330 when there is already a sufficient distance between the lower 306 and upper 305 snubber elements. Fluid is prevented from escaping the bore 391 by seals 394.

The upper snubber element 305 comprises a downwardly extending boss 395, receivable in a corresponding recess 396 provided on the upper surface 311 of the lower snubber element 306. The lower end 397 of the fluid supply bore 392 is disposed in the boss 395, and supplies fluid to the upper volume 350. Conveniently, the recess 396 is sized to distribute fluid to the upper volume 350 through lower end 397, even when the distance between the upper 305 and lower 306 snubber elements is small or, alternatively, even when upper 305 and lower 306 snubber elements abut.

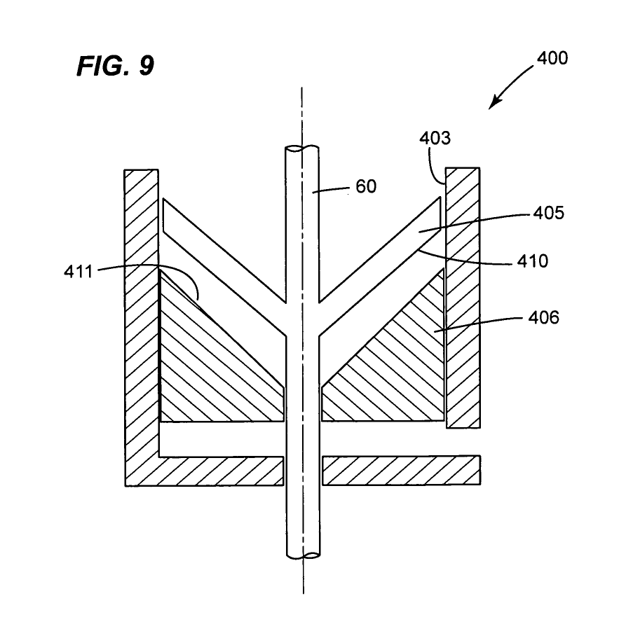

FIG. 9 shows a valve seating control device 400 according to a fourth embodiment of the present invention. In valve seating control device 400 an upper snubber element 405 is conical and rigidly connected to stem 60 of valve 24, so as to increase the surface area of its lower surface 410 relative to the use of a disc shaped upper snubber element (such as upper snubber element 105 in embodiment 100) disposed in the same diameter bore 403. The upper surface 411 of a lower snubber element 406 is provided with a corresponding conical surface. It will be appreciated that the upper 405 and lower 406 snubber elements otherwise operate substantially in the same manner as those of the other embodiments 100, 200, 300.

A valve seating control device 100, 200, 300, 400 embodying the present invention is suitable for use with any valve 24, 26 in which, during use, factors such as dimensional changes due to thermal expansion, wear and manufacturing tolerances may adversely affect the correct and accurate seating of the valve head on the valve seat. The device is particularly of use in high speed valves, more particularly a valve associated with a crossover passage of a split cycle engine.

The present invention provides a split cycle engine incorporating at least one seating control device for a valve embodying the present invention.

The valve seating control device 100, 200, 300, 400 as described herein and as shown in the attached figures is associated with the XovrC valve 24. Alternatively or additionally, the valve seating control device 100, 200, 300, 400 may be associated with the XovrE valve 26.

As described above, it is especially important with valves associated with crossover passages of a split cycle engine that the valve opens and closes as quickly as possible, to ensure the effective and quick passage of gas through the valve. In a cam actuated assembly, the landing ramp constitutes a predetermined portion of the overall cycle. Accordingly, at low engine speeds, the duration of the ramp may be longer than it needs to be.

In embodiments of the present invention, the actuation of the valve assembly may be unconnected and not proportional to the engine speed. Accordingly, landing events may be completed within substantially the same time, regardless of engine speed. Conveniently, therefore, even at low engine speeds, the valves may open and close quickly, allowing the effective and quick transfer of gases.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A seating control device for a valve, comprising:
a vessel for containing a fluid;
an upper snubber element translatably receivable in the vessel for controlling the seating velocity of a valve associated therewith; and
a lower snubber element translatably receivable in the vessel, adjacent the upper snubber element, presenting a surface to the upper snubber element, for controlling the seating of the valve.

2. A seating control device for a valve according to claim 1, configured such that the resistance to movement of the upper snubber element in the vessel is different to the resistance to movement of the lower snubber element in the vessel.

3. A seating control device for a valve according to claim 2, configured such that the resistance to movement of the upper snubber element in the vessel is less than the resistance to movement of the lower snubber element in the vessel.

4. A seating control device for a valve according to claim 2, wherein the average clearance between the upper snubber element and the wall of the vessel is different to the average clearance between the lower snubber element and wall of the vessel.

5. A seating control device for a valve according to claim 1, wherein a spacer is provided between the upper snubber element and the lower snubber element to limit the minimum separation between the upper snubber element and the lower snubber element.

6. A seating control device for a valve according to claim 1, wherein the position of the lower snubber element with respect to the vessel is hydraulically controlled.

7. A seating control device for a valve according to claim 6, wherein the vessel has a substantially closed end, the valve seating control device further having a lower port between the lower snubber element and the closed end of the vessel, through which a supply of the fluid may be introduced.

8. A seating control device for a valve according to claim 7, further comprising a pump to supply fluid under positive pressure to the lower port.

9. A seating control device for a valve according to claim 8, further comprising a control unit to control the supply of fluid to the vessel.

10. A seating control device for a valve according to claim 7, wherein a spacer is provided between the lower snubber element and the closed end of the vessel, to limit the minimum separation between the lower snubber element and the closed end of the vessel.

11. A seating control device for a valve according to claim 5, wherein at least a part of the spacer is resilient.

12. A seating control device for a valve according to claim 1, further comprising a lever associated with the lower snubber element to control its position with respect to the vessel.

13. A seating control device for a valve according to claim 12, further comprising a hydraulic lash adjuster associated with the lever.

14. A seating control device for a valve according to claim 13, further comprising a pump to supply fluid under positive pressure to the hydraulic lash adjuster.

15. A seating control device for a valve according to claim 14, further comprising a control unit to control the supply of fluid to the hydraulic lash adjuster.

16. A seating control device for a valve according to claim 1, further comprising an upper port provided between the upper snubber element and the lower snubber element through which a supply of fluid may be introduced.

17. A seating control device for a valve according to claim 16, wherein the upper snubber element is substantially disk shaped and the upper port is provided in the vicinity of the center of the lower face of the upper snubber element adjacent the lower snubber element.

18. A seating control device for a valve according to claim 7, wherein flow of fluid from the vessel through either or both the lower and upper ports is prevented.

19. A seating control device for a valve according to claim 1, wherein the upper snubber element is connected to a valve stem of the valve.

20. A seating control device for a valve according to claim 1, configured such that, in use, the distance between the upper and lower snubber elements, before the associated valve opens, converges towards a predetermined distance.

21. A split-cycle engine, comprising:
a crankshaft rotatable about a crankshaft axis;
a compression piston slideably received within a compression cylinder and operatively connected to the crankshaft such that the compression piston reciprocates through an intake stroke and a compression stroke during a single rotation of the crankshaft;
an expansion (power) piston slideably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including a crossover compression (XovrC) valve and a crossover expansion (XovrE) valve defining a pressure chamber therebetween; and
a seating control device associated with at least one of the crossover compression (XovrC) valve and crossover expansion (XovrE) valve, the device comprising:
a vessel containing a fluid;
an upper snubber element translatably receivable in the vessel for controlling the seating velocity of the valve; and
a lower snubber element translatably receivable in the vessel, adjacent the upper snubber element, presenting a surface to the upper snubber element, for controlling the seating of the valve.

22. A method of controlling the seating of a valve, the method comprising:
providing a seating control device comprising: a vessel containing a fluid; an upper snubber element translatably receivable in the vessel for controlling the seating velocity of a valve associated therewith; and a lower snubber element translatably receivable in the vessel, adjacent the upper snubber element, presenting a surface to the upper snubber element;
associating the upper snubber element with a stem of the valve, the upper snubber element controlling the velocity of the valve as the upper snubber element approaches the surface of the lower snubber element; and
controlling the position of the lower snubber element with respect to the vessel.
